(19) United States
(12) Patent Application Publication
(10) Pub. No.: US 2024/0139056 A1
(43) Pub. Date: May 2, 2024

(54) Walker Caddy

(71) Applicant: Michael Farris, Indianapolis, IN (US)

(72) Inventor: Michael Farris, Indianapolis, IN (US)

(21) Appl. No.: 18/497,003

(22) Filed: Oct. 30, 2023

Related U.S. Application Data
(60) Provisional application No. 63/421,604, filed on Nov. 2, 2022.

(51) Int. Cl. A61H 3/00

(52) U.S. Cl. CPC A61H 3/00; A61H 2003/004

(57) ABSTRACT

The present invention relates to a novel attachment for a walker or mobility assistance device. The attachment is a storage unit that allows for the safe and easy transportation of food, beverages, medicine, tools, pet or other items while using a walker. The device includes a rectangular tray that clamps onto the frame of a walker. The tray also has a lid to further secure the contents inside. The device also has a beverage holder that attaches to one of the legs or support frame of a walker. The beverage holder is cylindrical in shape to accommodate glasses, bottles, or cans. Furthermore, both the tray and beverage holder of the present invention are removably attachable.

### CROSS-REFERENCE TO RELATED APPLICATION

The present application claims priority to, and the benefit of, U.S. Provisional Application No. 63/421,604, which was filed on Nov. 2, 2022, and is incorporated herein by reference in its entirety.

### FIELD OF THE INVENTION

The present invention relates generally to the field of walking assistance devices. More specifically, the present invention relates to an improved walker having a convenient carrier or caddy which is removably connected to the walker and provides users with a secured storage unit and beverage holder used for transporting food, beverages, tools, pet accessories, and other items while using a walker. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in walking assistance devices. Specifically, improvements in the user experience for those individuals that have to use walkers, whether a rolling or non-wheeled assist or other similar devices. The present invention comprises an attachable tray and beverage holder for transporting food, beverages, tools, pet accessories, and other items while using a medical walker. Devices for transporting items while using a walker are generally desired in the art to provide more accessibility and convenience for users who require a walker or other mobility assist device. One particular area of concern is that while using both hands to operate a walker or other mobility assist, the user cannot transport multiple other items. For example, while using a traditional walker, a user finds themselves having to return to the kitchen multiple times to retrieve separate parts of a single meal or to go to other areas to obtain accessories that the user may need to complete a task. This process can be very frustrating and tiresome.

Furthermore, with a traditional walker or mobility assist device, if a user attempts to carry multiple items while still relying on the walker, the situation can become dangerous rather quickly. Prior art solutions include hanging a bag or pouch off one side of the walker or mobility assist but that can lead to the walker or mobility assist device tilting to one side and potentially destabilizing the user and causing them to fall. By focusing on carrying these other items, their physical stability can become compromised and the user may fall and seriously injure themselves. Another problem is that if the user were to drop or spill a liquid-based item while using the walker or mobility assist device, the floor may become slippery, which also may result in a fall.

Specifically, the present invention relates to a tray or bin that attaches to a medical walker or other mobility assistance device to transport food, tools, remote controls, accessories, or other items. The tray or bin securely clamps to the frame of the walker or mobility assistance device, freeing both hands of the user to properly use the walker or mobility assistance device. The device also features a beverage holder for the same purpose described.

Therefore, there exists a long-felt need in the art for a storage unit for transporting food, beverages, remotes, tools, medicine, pet and other accessories, and other items while using a walker or mobility assistance device. There is also a long-felt need in the art for a walker or mobility assistance storage unit or caddy that features a secure lid to prevent the spilling of liquid-based or other items. There is also a long-felt need in the art for a walker or mobility assistance storage unit that allows users to transport multiple items and accessories while keeping both hands free to properly use the walker or mobility assistance device. Furthermore, there is a long-felt need in the art for a walker or mobility assistance storage unit that allows users to transport multiple items without the assistance of another individual.

The subject matter disclosed and claimed herein, in one embodiment thereof, comprises a caddy attachment for a walker or mobility transporter. The device is a walker or mobility storage unit that allows users to transport multiple items that an individual may need at one time in a safe and secure manner. The device includes a tray that is securable to the frame of a walker or mobility assistance device to transport food, medicine, remotes, various accessories, and other items. The tray also features a lid to prevent spilling of the items being transported or carried. The invention also includes a cylindrical beverage holder that is removably attachable to one of the legs of a walker frame for the transportation of beverages.

The mobility assistance caddy may also be configured to provide a light, such a LED light, or a series of lights to illuminate an area, a speaker for playing music or alerting others, and a battery compartment for powering the lighting source and speaker.

In this manner, the walker or mobility assistance transporter of the present invention accomplishes all the foregoing objectives and provides users with a device that allows for the safe and secure transportation of multiple items at one time while keeping both hands free to use the walker or the mobility assistance device.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The present invention provides an improvement for use with walking or mobility assistance devices. The walker transporter or caddy features an attachable tray and beverage or accessory holder. The tray and accessory/beverage holder allow users to transport food, medicine, and other items with them while keeping both hands free to safely use the walker or mobility assistance device. This eliminates the need to travel many times back and forth to bring different items to a desired location where the individual is to perform a task. The tray attaches to the frame of a walker and can be sealed with a lid or other cover to prevent the spillage of items being transported. The beverage holder attaches to a leg of the walker allowing the transportation of beverages.

In one embodiment, an attachment is provided for a walker or mobility assist device and features a tray or caddy component that is removably attachable to the cross bars of a medical walker frame. The tray component allows for the transportation of food, medicine, accessories, or other items while using a walker or mobility assist. The tray attaches via a clamping mechanism, magnets, snaps, other mechanical fasteners, hook and loop fasteners, or other suitable attachment element found on two opposing sides of the tray.

In one embodiment, the tray component and attaching lid or cover are manufactured from heat-sealable plastic or polymers, such as polypropylene or acrylonitrile-butadiene-styrene (ABS), or metals, such as aluminum, stainless steel, etc.

In another embodiment, the tray component of the walker or mobility assistance transporter features a plurality of individual compartments as well as specifically sized areas such as a silverware compartment, although any arrangement of compartments deemed suitable for the purpose described may be used. The individual compartments can be of varying sizes and/or shapes in order to accommodate user need and/or preference.

In another embodiment, the tray component features a lid or cover to further secure the items inside, preventing spilling or contents from falling.

In one embodiment, the tray component may be manufactured from a dishwasher safe material allowing easy cleaning. The transporter or caddy can also be produced with an anti-microbial material to prevent the spread of germs or other contaminants.

In a further embodiment, the walker or mobility assistance transporter includes a beverage holder. This beverage holder is generally cylindrical in shape and attaches to one of the legs of the walker allowing for the transportation of a beverage or other cylindrically shaped items such as medicine containers.

In one embodiment, the beverage holder attaches to a leg of the walker using a hook and loop strap although any securing means such as magnets or other mechanical fasteners deemed suitable for the purpose described may be used.

In one embodiment, the beverage holder is manufactured from heat-sealable plastic or polymers, such as polypropylene or acrylonitrile-butadiene-styrene (ABS), or metals, such as aluminum, stainless steel, etc.

In a further embodiment a method of making a transporter or caddy is disclosed and includes accessing a website by a smartphone, tablet, or computer, and selecting a plurality of compartments, designing the compartment sizes, choosing a fastening arrangement, color, and adding any other personalization desired by a user.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the food tray and beverage holder of the present invention. The tray and beverage holder are shown attached to a medical walker in accordance with the disclosed specification;

FIG. 2 illustrates a closer perspective view of one embodiment of the tray component of the present invention illustrating the clamps and various compartments in accordance with the disclosed description;

FIG. 3 illustrates a perspective view of one embodiment of the tray and lid components of the present invention in accordance with the disclosed specification; and

FIG. 4 provides a block diagram illustrating an exemplary method for designing a walker or mobility assistance caddy.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a walker or mobility assistance storage unit for transporting food, medicine, beverages, tools, remotes, accessories, and other items while using a walker or mobility assistance device. There is also a long-felt need in the art for a walker or mobility assistance storage unit or caddy that features a secure lid or cover to prevent the spilling of liquid-based items and preventing items from falling out of the unit. There is also a long-felt need in the art for a walker or mobility assistance storage unit or caddy that allows users to transport multiple items while keeping both hands free to properly use the walker or mobility assistance device. Finally, there is a long-felt need in the art for a walker or mobility assistance storage unit or caddy that allows users to transport multiple items without the assistance of another individual or having to make multiple trips to pick up additional items.

The present invention, in one exemplary embodiment, is a novel storage unit for use with a walker or other mobility assistance device. The invention is a utility carrier for transporting food, beverages, medicine, remote controls, pet and other accessories, or other items safely while using a walker or mobility assistance device. The invention comprises a generally rectangular or quadrate tray with multiple compartments which may be of similar sizes or different sizes depending on a configuration selected by a user. The tray component clamps or is secured to the frame of a medical walker or mobility assist and has a lid or cover to further secure the contents inside the caddy or transporter. The invention also has a beverage holder. The beverage holder is generally cylindrical and attaches to one of the walker's legs or support for the transportation of beverages or other items which may fit within the holder. Further, the invention allows the transportation of food, beverages, medicine, tools, pet or other accessories, or other items without requiring the assistance of a second individual or the need to make multiple trips to pick up additional items.

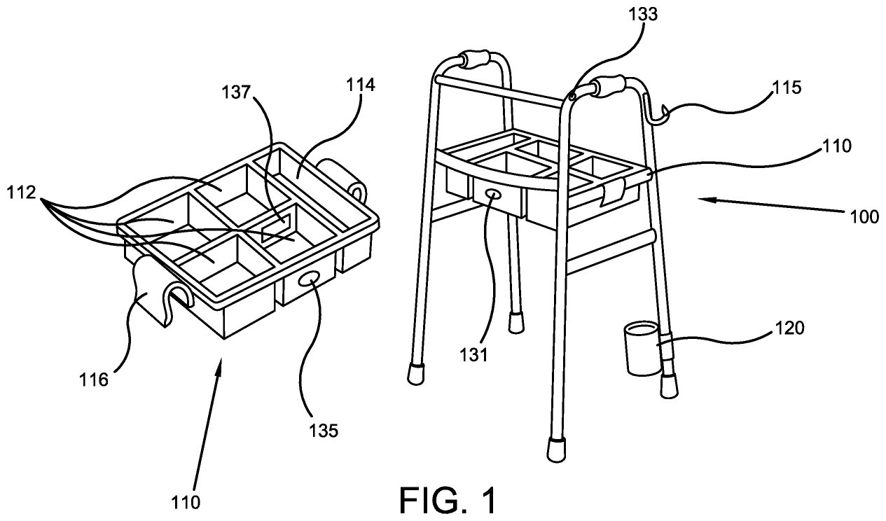

Referring initially to the drawings, FIG. 1 illustrates a perspective view of one embodiment of the walker or mobility assist caddy or transporter 100 of the present invention. The tray 110 and beverage holder 120 are shown attached to a medical walker or mobility assistance device, which may be a rolling type of mobility assist or a wheelless configuration, in accordance with the disclosed specification. In the present embodiment, the walker transporter or caddy 100 is a device that allows users to transport food, beverages, medicine, remote controls, tools, pet and other accessories, and other items while keeping both hands free to safely use a walker or mobility assistance device. The walker transporter or caddy 100 is especially designed to allow any suitable user as is known in the art, to transport food, beverages, medicine, remote controls, tools, pet and other accessories, and other items in one trip, eliminating the need for multiple trips, the assistance of another individual, or having to hang bags or pouches off the side of the mobility assistance device. More specifically, the walker transporter or caddy 100 comprises a generally rectangular or quadrate shaped tray component 110 with a plurality of food compartments 112 and may include one or more specifically sized compartments, such as a silverware holder 114, to retain food and silverware while using a walker or mobility device.

The walker transporter or caddy 100 also has a beverage holder 120 that attaches to one of the legs or supports of a walker for the transportation of beverages or other items that can fit within the sized holder.

In the present embodiment, the tray 110 is generally rectangular or quadrate in shape and attaches to the frame of a walker via clamps or other fasteners 116, although any attachment means deemed suitable for the purpose described may be used, such as magnets, mechanical fasteners, such as snaps, hook and loop fasteners, adhesive, such as removable, repositionable, or permanent types of adhesive, or various combinations of fasteners. This allows the tray 110 to remain stable and secure on a walker or mobility assistance frame during use. The tray or caddy 110 may be detached once a user has reached the desired location or if the user no longer needs the tray or caddy, thereby allowing the user to eat directly from it or use it for another purpose. The tray or caddy 110 then may be reattached to the walker or mobility assist frame to transport it to the sink or dishwasher after use.

In the present embodiment, the beverage holder 120 is generally cylindrical in shape and has a diameter of about 3 inches and is about 5 inches tall allowing the transportation of a glass, bottle, or can. The beverage holder attaches to one leg or support of a walker or mobility assist device. This may be accomplished by way of a hook and loop straps, clamp, magnets (e.g., neodymium iron boron, samarium cobalt, aluminum nickel cobalt, ferrite), mechanical fasteners (e.g., snaps buttons, etc.), adhesive (e.g., permanent, removable, repositionable) or any other attachment connection means or combination thereof deemed suitable for the purpose described.

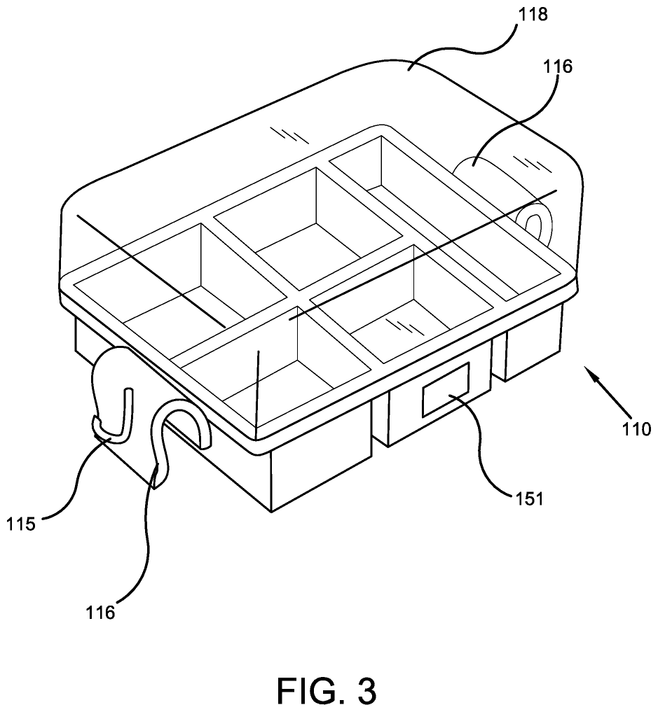

FIG. 1 also shows a light 135 which is provided on one or more sides of the tray or caddy 110. The tray or caddy 110 may also have a speaker 135 which can be used to play music, sounds, or to call for help. The speaker 131 and light 135 may also be connected to a battery 137 to provide a power source for the elements. The speaker 131 and light 135 may be activated by a switch 133 which is located on the handle or other suitable location on the walker or mobility assistance device. The caddy 110 may also be provided with a hook 115 which may be placed on the side of the walker 100 or on the side of the caddy as shown in FIG. 3 to hold a towel, wrap, or coat when the individual is not using the apparel or other item.

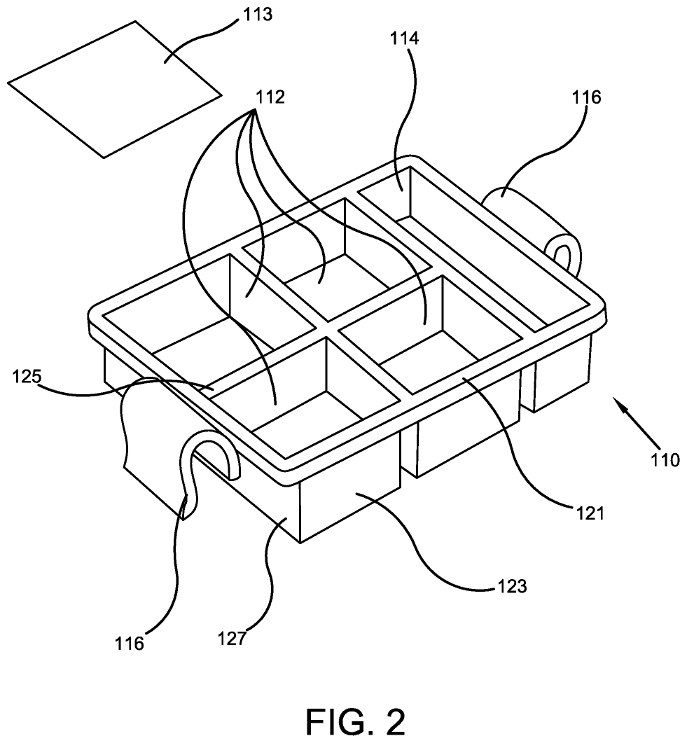

As shown in FIG. 2, the tray or caddy 110 has a plurality of separate compartments 112 and may include a compartment which is specifically sized to hold particular implements, such as a silverware holder or a tool 114, and fastening elements 116. The compartments 112 are generally rectangular or square in shape allowing for maximum space to hold items, although any shape or configuration of the compartments 112 may be used to suit the needs of users. The specific holder 114 is also generally rectangular or quadrate in shape, although more elongated to allow for the length and width of the specific item such as standard silverware. One or more of the compartments 112 may have a removable component 113 which allows the individual to remove the compartment 113 from the caddy 110. The removable component 113 may also have an absorptive material in the base such as a sponge to hold spills or liquids, such as condensation from items placed in the compartment 112 or 113. The compartments 112 may be of the same size or different sizes and have a depth ranging from 2 inches to about 6 inches. In a quadrate or rectangular configuration, the compartments 112 have a width of 4 inches to about 6 inches and length of 4 inches to 6 inches. If different sized compartments are provided, then the width may range from 1 inch to 10 inches and a length of 1 inch to 10 inches. The clamps or fastener elements 116 are attached to one of the side walls 123 or end walls 127.

The caddy or transporter 110 has side walls 123 and end walls 127 which may be continuous or discontinuous depending on the construction of the caddy 110. The caddy 110 has a top edge 121 which runs around the periphery of the caddy 110. A series of ribs 125 run from the top edge 121 and defines the individual compartments 112. The series of ribs 125 are shown as both running perpendicular and parallel to the top edge to define the individual compartments 112.

As shown in FIG. 3, the tray or caddy 110 of the present invention 100 may include a lid or cover 118 that attaches to the top of the tray 110 to further secure the contents inside. In one embodiment, the lid may lock onto the tray 110 for added security. A hook 115 may be mounted on one of the fastening elements 116 or the side walls 123 or end walls 127 depending on the preference of the user. The user may add indicia or other graphics 151 to further personalize the caddy or transporter 110.

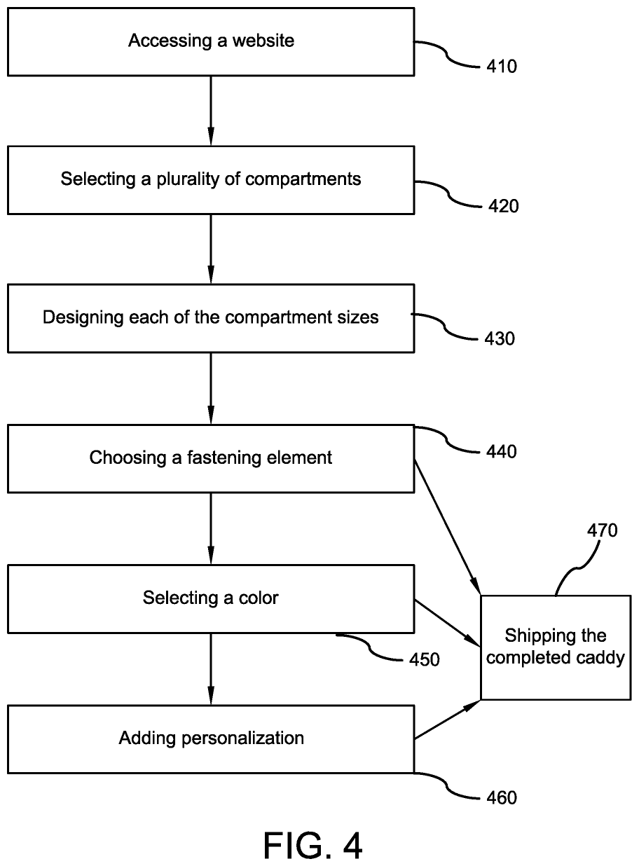

FIG. 4 shows an exemplary flow diagram of a method of making a transporter or caddy for a walker or other mobility assistance device. Initially, a user logs on to a website at step 410, using a smartphone, tablet, computer, or other smart device. At step 420, the user can select the number of compartments for the caddy. At step 430, the user selects the size and dimension of each of the compartments selected in step 420. Next, at step 440, the user selects a fastening or securing element such as mechanical fasteners, magnetic fasteners, hook and loop fasteners, adhesive, and other suitable securing elements or combination thereof. The user selects a color at step 450, and then may add any personalization element at step 460, such as names, logos, shapes, graphics, and other features that a user may desire. If no color is selected, the caddy is shipped with a default color, such as gray, white, or black. The completed caddy is shipped at step 470 and the shipping may occur after any of the steps 440, 450 or 460, depending on whether the user wants to continue with any of the other steps.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “walker transporter”, “walker storage unit”, “walker caddy” and “storage unit” are interchangeable and refer to the walker or mobility assistance transporter 100 of the present invention.

Notwithstanding the foregoing, the walker transporter 100 of the present invention can be of any suitable size and configuration as is known in the art without affecting the overall concept of the invention, provided that it accomplishes the above-stated objectives. One of ordinary skill in the art will appreciate that the walker transporter 100 as shown in FIGS. 1-4 are for illustrative purposes only, and that many other sizes and shapes of the walker transporter 100 are well within the scope of the present disclosure. Although the dimensions of the walker transporter or caddy 100 are important design parameters for user convenience, the walker transporter or caddy 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attachment for a walker or mobility assistance device, the attachment comprising:
a caddy having side walls and end walls and a top edge that extends around a periphery of the caddy;
a plurality of ribs connected to the periphery;
a plurality of compartments, defined by the end walls, side walls, the top edge and the plurality of ribs; and
a plurality of fastening elements attached to one of the side walls or end walls to hold the caddy to a support frame of the walker or mobility assistance device.

2. The attachment as recited in claim 1, wherein the plurality of fastening elements are comprised of at least one of a mechanical fastener, a magnetic fastener, a hook and loop fastener, an adhesive fastener or a combination thereof.

3. The attachment as recited in claim 2, wherein the adhesive fastener is a select one of a permanent adhesive, a repositionable adhesive, or a removeable adhesive.

4. The attachment as recited in claim 2, wherein the magnetic fastener is comprised of a select one of a neodymium iron boron, a samarium cobalt, an aluminum nickel cobalt, or a ferrite.

5. The attachment as recited in claim 2, wherein the mechanical fastener is a snap or a button.

6. The attachment as recited in claim 1, wherein at least one of the plurality of compartments comprises a removable compartment.

7. The attachment as recited in claim 6, wherein the removable compartment comprises an absorptive element.

8. The attachment as recited in claim 1, wherein each of the plurality of compartments has a depth ranging from 2 inches to about 6 inches.

9. The attachment as recited in claim 1, wherein each of the plurality of compartments has a shape that is either rectangular or quadrate.

10. The attachment as recited in claim 1 further comprising a cylindrical holder attached to the support frame.

11. The attachment as recited in claim 1 further comprising a lid provided over each of the plurality of compartments.

12. A transporter for attachment to a walker, the transporter comprising:
a plurality of compartments defined by end walls, side walls, a plurality of ribs and a top edge;
a plurality of fastening elements attached to at least one of the side walls or end walls, wherein the plurality of fastening elements are comprised of a mechanical fastener, a magnetic fastener, a hook and loop fastener, an adhesive fastener or a combination thereof; and
a lid sized and configured to cover the plurality of compartments, wherein the lid is repositionable between an open position and a closed position.

13. A transporter for attachment to a walker as recited in claim 12 further comprising a battery source and a light attached to one of the side walls or end walls, wherein the light is powered by the battery source.

14. A transporter for attachment to a walker as recited in claim 13 further comprising a speaker attached to one of the side walls or the end walls, wherein the speaker is powered by the battery source.

15. A transporter for attachment to a walker as recited in claim 12, wherein the plurality of compartments comprise quadrate or rectangular shaped compartments.

16. A transporter for attachment to a walker as recited in claim 12, wherein the plurality of compartments are sized and configured to receive and hold a silverware or a tool.

17. A transporter for attachment to a walker as recited in claim 12, wherein each of the plurality of compartments have a depth ranging from 2 inches to about 6 inches.

18. A transporter for attachment to a walker as recited in claim 12, wherein the magnetic fastener comprises a neodymium iron boron, a samarium cobalt, an aluminum nickel cobalt, a ferrite adhesive fastener, and the adhesive fastener comprises a permanent fastener, a repositionable fastener, or a removeable adhesive.

19. A method of making a caddy or transporter for a walker or mobility assistance device, the method comprising the steps of:
accessing a website;
selecting a plurality of compartments;
designing a size for each of the plurality of compartments;
choosing a fastening element;
selecting a color; and
adding personalization.

20. The method as recited in claim 19 further comprising a step of shipping the caddy or transporter after the step of adding.
